(19) United States
(12) Patent Application Publication
(10) Pub. No.: US 2009/0100628 A1
(43) Pub. Date: Apr. 23, 2009

(54) WIPER SYSTEM FOR VEHICLE WINDOWS

(75) Inventors: Frank Wondratschek, Stuttgart (DE); Michael Schauble, Vaihingen/Enz (DE); Bruno Egner-Walter, Heilbronn (DE)

Correspondence Address: OSHA LIANG L.L.P., TWO HOUSTON CENTER, 909 FANNIN, SUITE 3500, HOUSTON, TX, 77010, US

(73) Assignee: VALEO SYSTEMES D'ESSUYAGE, La Verriere (FR)

(21) Appl. No.: 12/300,551

(22) PCT Filed: May 30, 2007
(86) PCT No.: PCT/EP07/04751

§ 371 Date: Nov. 12, 2008

(30) Foreign Application Priority Data
Jun. 8, 2006 (DE) 10 2006 026 664.1

(51) Int. Cl. B60S 1/04

(52) U.S. Cl. 15/250.31

(57) ABSTRACT

Wiper system for vehicle windows, in particular for vehicle windscreens, with at least one wiper shaft which is mounted in a wiper shaft bearing and can be driven by a wiper drive, with a wiper arm end which is fastened to the wiper shaft end protruding from a vehicle body, and with an axial securing element for securing the wiper shaft against axial displacement, wherein the axial securing element releases the wiper shaft for axial yielding in the event of the wiper shaft and/or the wiper arm end being subjected to an external application of force which exceeds a release force.

The invention concerns a wiper module for vehicle windscreens, particularly for vehicle front windscreens according to the generic term of patent claim 1.

The wiper shafts and the elements of a wiper module provided on the latter, such as wiper arms or pivot components of such wiper arms etc., projecting over the outside or external outline of the vehicle bodywork represent a considerable safety hazard for injuries in the event of accidents, particular also those involving pedestrians and/or cyclists.

In order to minimise the risk of injury, it is known to fundamentally design windscreen wiper modules for vehicles such that in case of an application of force exceeding a specific threshold value or a specific release force, particularly also in an axis direction parallel or approximately parallel to the wiper shaft axis, the wiper shaft deflects axially into the interior of the vehicle bodywork. This can be realised for example by a motor or wiper plate having the pivot for the wiper shaft (wiper shaft bearing) being held on the vehicle bodywork by fixing devices, which in case of an application of force exceeding the release force releases the connection between the wiper plate and the vehicle bodywork (DE 198 33 488 A1).

Known also are embodiments wherein the wiper shaft is designed for axial displacement in its wiper shaft bearing, but is secured against axial displacement by an axial securing element for normal wiping operation. This axial securing element is for example a lockwasher received in a circumferential slot, which in the normal condition of the wiper module rests against a surface of the wiper shaft bearing, thereby safeguarding the wiper shaft against axial displacement (DE 198 51 881 A1). The circumferential slot is slightly angled on its side distant from the wiper shaft bearing, so that in case of an application of force exceeding a release force on the wiper shaft and on the end of the wiper arm connected to the latter, the lockwasher is widened by the angled side of the circumferential slot in such a way that the wiper shaft slides axially through the lockwasher which in turn lies against the wiper shaft and can therefore deflect axially within the wiper shaft bearing.

The disadvantage in all the known solutions is that triggering of the personal protection, i.e. release of the wiper shaft for axial deflection, only occurs with a relatively pronounced external application of force, i.e. the release force is relatively high. This results from the fact that the forces that arise during normal wiping operation must not result in triggering of the personal protection and the protection function and to this end, wiper modules must pass among other aspects all tests, such as for example constant running, blocking test, snow load test, etc. without the protection function being triggered.

The aim of the invention is to demonstrate a wiper module that avoids the aforementioned disadvantages. In order to solve this problem, a wiper module according to patent claim 1 is designed.

Triggering or unlocking mechanism in the sense of the invention implies any kinematics provided in addition to the wiper shaft and any mechanism provided in addition to the wiper shaft that in case of an application of force exceeding the release force, renders the axial securing element out of action, to be more precise through detachment or by demeshing of the axial securing element from the wiper shaft, so that axial displacement and deflection of the wiper shaft in relation to the wiper shaft bearing and therefore also axial displacement of the wiper shaft in the inwards direction in relation to the vehicle bodywork may occur.

In the invention, the necessary stability of the wiper module for normal operation and the release force decisive for triggering the protection function are dissociated from one another. Triggering of the protection function and release of the axial securing element and the associated release of the wiper shaft for axial deflection are performed by a triggering or unlocking mechanism which is initiated in case of an accident with the external application of force. This triggering or unlocking mechanism interacting with the axial securing element can, according to various different embodiment possibilities, be formed by the cover cap or by a section of this cover cap. Another possibility consists in providing a control element movable for example in relation to the pivot component of the wiper arm, which with the presence of a cover cap covering the pivot component of the wiper arm, is likewise located under this cover cap.

In a preferred embodiment of the invention, release of the axial securing element occurs radially or approximately radially to the wiper shaft axis. It is possible as a result to design the axial securing element such that during normal wiping operation, it is capable of taking up high axial forces of the wiper shaft, on triggering of the protection function, i.e. for release of the wiper shaft for axial deflection however, can be removed radially or approximately radially from the wiper shaft with limited exertion of force.

Further developments of the invention are the subject of the subclaims.

The invention is described below in further detail in examples of embodiment based on the figures.

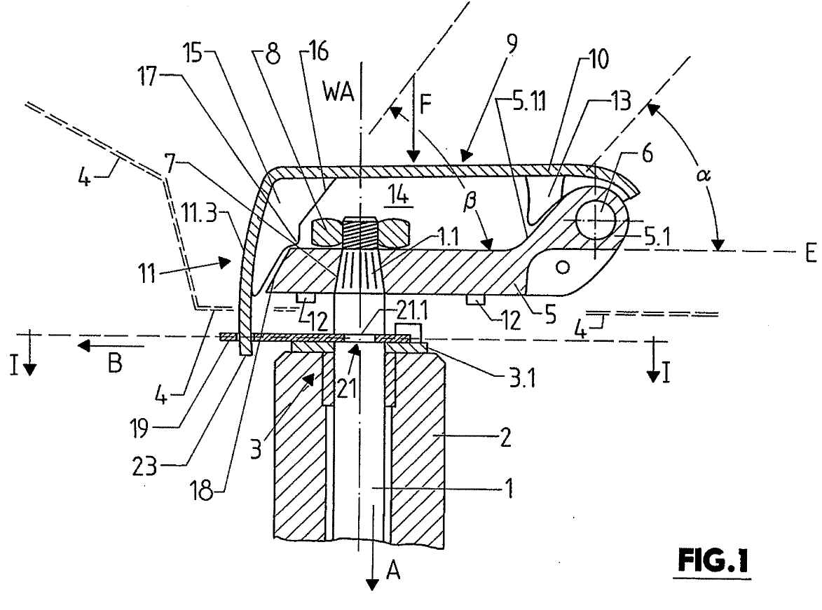

FIG. 1 shows a simplified representation of a section through a wiper shaft bearing, together with the wiper shaft and a pivot component fixed to the wiper shaft of an otherwise non-illustrated wiper arm of a wiper module for vehicles;

FIG. 2 shows a top view of the pivot component and the cover cap;

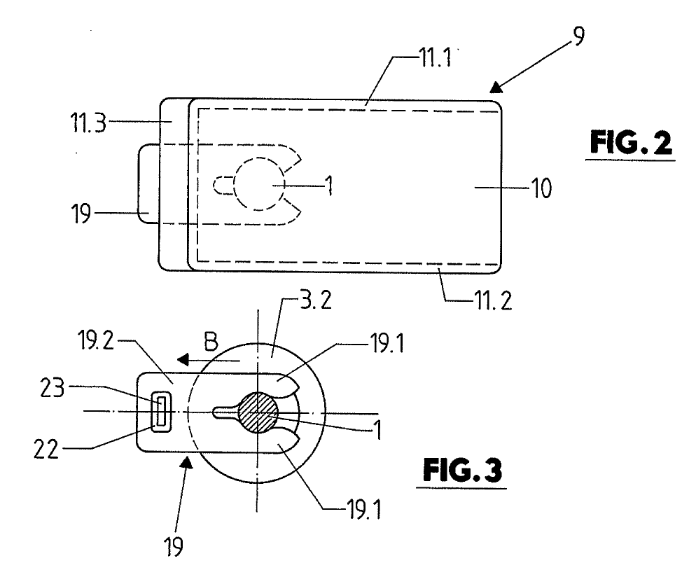

FIG. 3 shows a section according to the line I-I in FIG. 1;

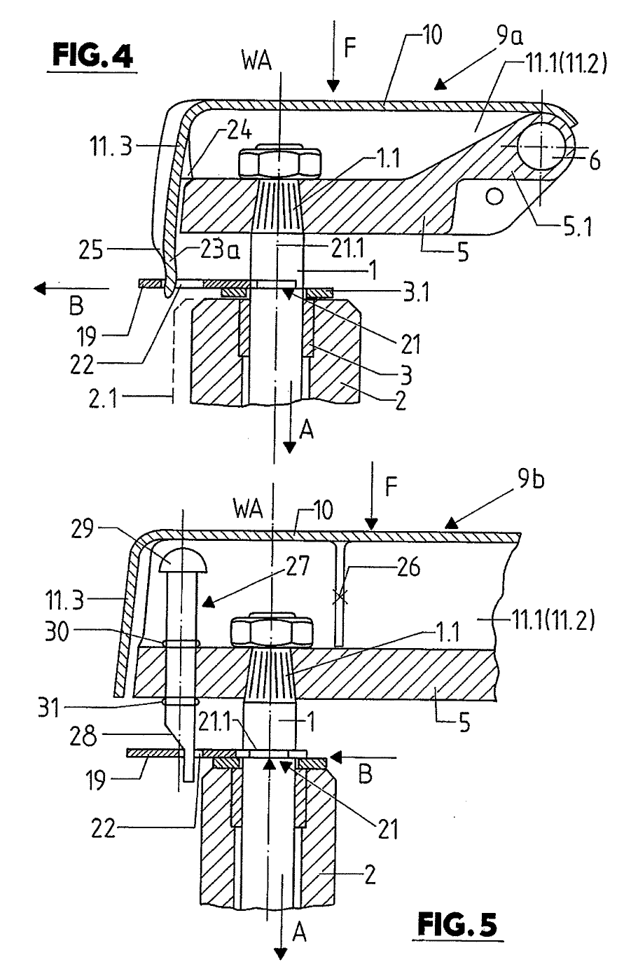

FIG. 4-6 shows further embodiments of the invention in representations similar to those of FIG. 1;

FIG. 7 shows an enlarged partial representation of a cap covering the wiper shaft and the pivot component, together with an axial securing element for axial securing of the wiper shaft in the form of a circlip;

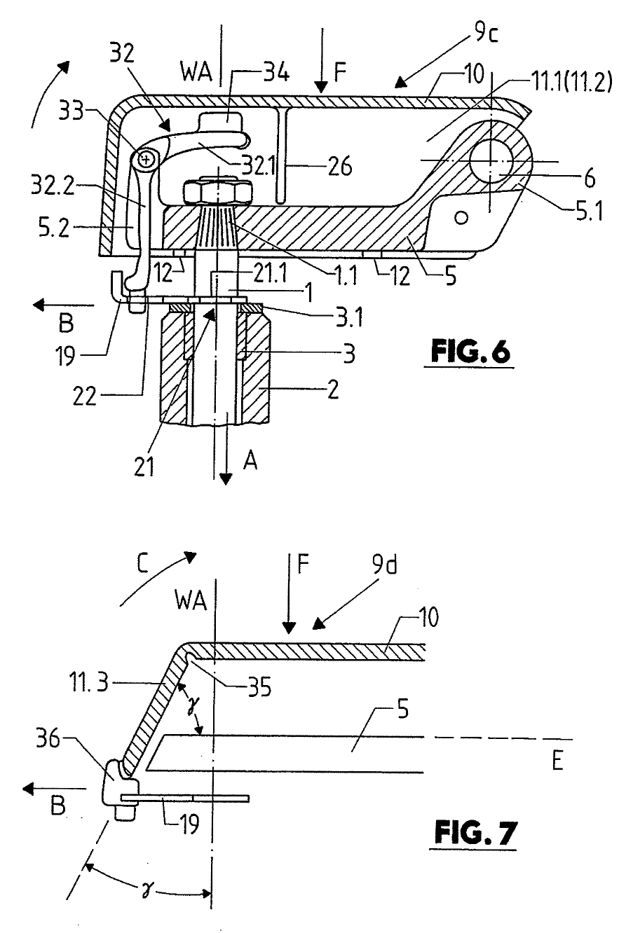

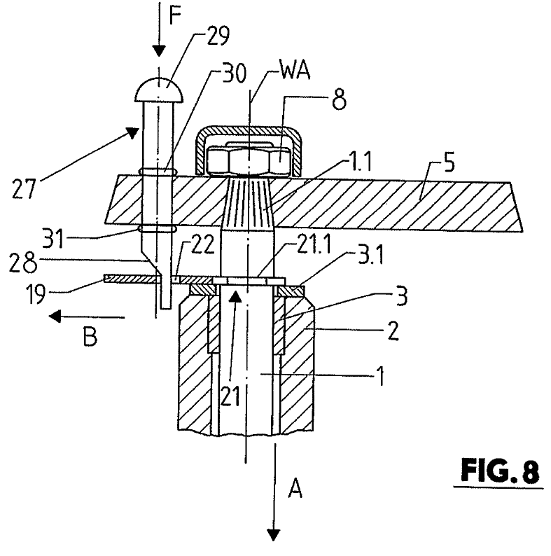

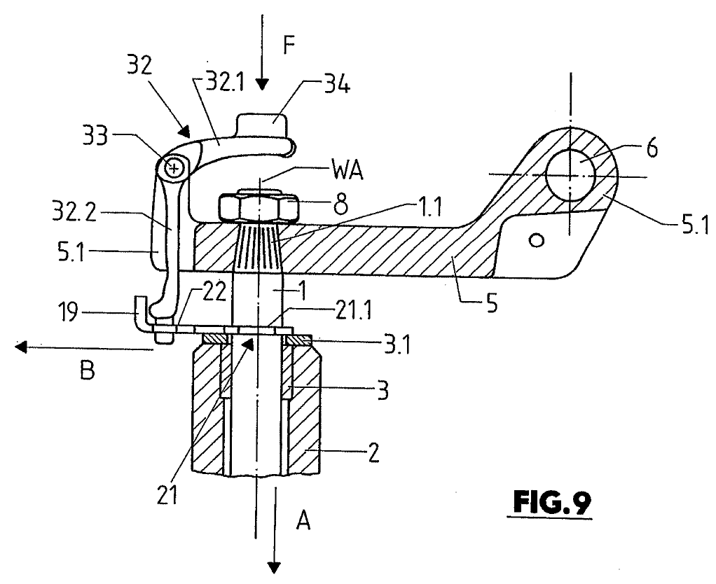

FIGS. 8 and 9 shows representations similar to FIGS. 5 and 6 of further embodiments of the invention;

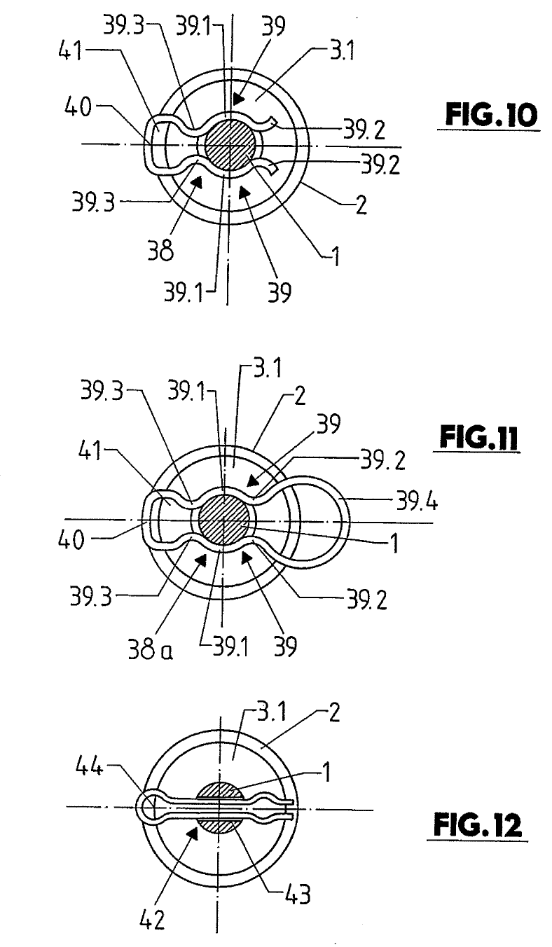

FIG. 10-12 shows similar representations as FIG. 3 with other embodiments of the invention.

In the figures, 1 is the wiper shaft of an otherwise non-illustrated windscreen wiper module for vehicles, for private cars for example. The wiper shaft 1 driven in pivoting fashion around the wiper shaft axis WA by a likewise non-illustrated windscreen wiper gear is pivot-mounted and swivel-mounted around the axis WA in a wiper shaft bearing 2 with the aid of bearing bushes 3.

The wiper shaft bearing 2 is attached to the vehicle bodywork for example, which is generally implied by the line 4 in FIG. 1 or to a plate, e.g. the tubing plate of the windscreen wiper module. A pivot component 5 is fixed to the wiper shaft end 1.1 projecting outwards from the wiper shaft bearing 2 and also over the vehicle bodywork 4, which is part of the non-illustrated wiper arm and to which, with the aid of a pivot bolt reaching through a bearing opening 6, a wiper arm element bearing the wiper blade (e.g. an articulated component with a wiping rod) is pivot-mounted in the manner well known to the specialist. An adapted opening 7 is provided in the pivot component 5 for fixing the pivot component 5 to the wiper shaft end 1.1 of truncated cone-shaped design. A nut 8 serves for clamping and axial securing of the pivot component 5 on the shaft end 1.1.

The pivot component 5 is covered by a hood-like cover cap 9, which is formed of a malleable material, for example as a single piece from plastic, with an upper wall section 10 and a circumferential wall 11 and indeed in such a manner that the cover cap 9 applied to the pivot component 5 and maintained at this position by notches 12 covers the pivot component 5 with the upper wall section 10 in a top view from above and also with the circumferential wall 11 at the circumference and to be more precise at three circumferential wall sections 11.1, 11.2 and 11.3 adjoining each other in the angle. In the area of the bearing opening 6, the cover cap 9 with its upper wall section 10 is adjacent to a raised area 5.1 of the pivot component 5 and is supported at this position by means of one or several bridge 12 on an angled surface 5.1.1. of the pivot component 5, which (surface) forms an angle α with a plane E oriented vertically to the wiper shaft axis WA, which (angle) opens towards the opening 7 for the side facing away from the wiper shaft end 1.1.

The bearing opening 6 is provided in a raised section 5.1 of the pivot component which projects over the upper side of the remaining pivot component 5 facing away from the wiper shaft bearing. In the embodiment presented, the pivot component 5 is furthermore designed such that outside the raised area 5.1, the upper side and bottom side of the pivot component 5 lie respectively in a plane oriented vertically to the wiper shaft axis WA.

The cover cap 9 is furthermore designed such that not only is the wiper shaft end 1.1 with the nut 8 received in the space 14 covered by this cover cap 9, but the upper side of the pivot component 5 (outside the section 5.1) and also the wiper shaft end 1.1 with the nut 8 are markedly at a distance from the bottom side of the wall section 10 in an axis direction parallel to the wiper shaft axis WA.

On the inside of the cover cap 9, in the area of the rearward section 11.3 located at a distance from the bearing opening 6, a bridge 15 is formed on the inside of this section, which connects section 11.3 to the upper wall section 10 and forms an angled surface 16, which, with the cover cap installed, forms an angle β with the wiper shaft axis WA, which opens towards section 5.1. On the angled surface 16, a nose 17 projecting over this angled surface is formed, by means of which the cover cap 9 on the side distant from the bearing opening 6 is supported on the upper side of the pivot component 5 facing away from the wiper shaft bearing 2, so that the cover cap 9 is attached by locking by means of the notches 12 engaging behind the pivot component on the bottom side and by the bridges 13 and the nose 17 on the pivot component 5.

The angled surface 16 is arranged adjacent to an angled surface 18 on the side of the pivot component 5 distant from the bearing opening 6. The angled surface 18 likewise forms the angle β with the plane E. The angles α and β are respectively smaller than 90° and approximately 45° or more. Furthermore, both angles α and β are for example equal.

The wiper shaft 1 and the functional elements connected to this wiper shaft can be displaced from the normal position represented in FIG. 1 in the direction of the wiper shaft axis WA, as implied by the arrow A and to be more precise, by a length corresponding to the distance between the bottom side of the pivot component 5 and the wiper shaft bearing 2. An axial securing element serves for axial securing of the wiper shaft 1 in the normal position, which is formed by a clip element or circlip 19 in the embodiment presented. This is manufactured for example from a flat material, for instance from spring steel or from a suitable plastic and to be more precise, with two clip arms 19.1, which overlap the wiper shaft 1 in the manner of a fork in the area of a circumferential groove 21 provided in this wiper shaft, into which (groove) the clip arms 19.1 each partially extend. The circlip 19 is supported for axial securing of the wiper shaft 1 on the wiper shaft bearing 2 by means of an overrun washer 3.1, in order to reduce the friction between the circlip 19 which is pivoted with the wiper shaft and the wiper shaft bearing 2 on pivoting of the wiper shaft 1 and the wiper arm fixed to the latter during wiping operation. The overrun washer 3.1 therefore forms an axial support surface on the wiper shaft bearing side and the side distant from the wiper shaft bearing 2 or delimiting surface of the circumferential groove 21 forms an axial support surface 21.1 on the wiper shaft side respectively for the circlip 19.

In an area 19.2 connecting the two clip arms 19.1 and projecting radially from the wiper shaft 1, the circlip 19 possesses an entrainer or control opening 22, into which a bridge-like extension 23 reaches, which is formed in the manner of a projection on the cover cap 9 over the bottom edge of the rearward section 11.3. The circlip 19 projects radially with its section 19.2 presenting the control opening 22 from the wiper shaft 1 and to be more precise in such a way that the control opening 22 is located on the side of the wiper shaft axis WA facing away from the bearing opening 6.

By means of the design of the cover cap 9 and the circlip 19 serving for axial securing, it is achieved that in the event of external application of force on the upper wall section 10 of the cover cap 9 according to the arrow F in FIG. 1, i.e. particularly in case of an accident involving a person, by over-depression of the catch formed by the nose 17 and by sliding of the bridges 13 on the angled surface 5.1.1 and the angled surface 16 on the angled surface 18, displacement of the cover cap 9 in relation to the pivot component 5 among other aspects occurs in an axial direction radially in relation to the wiper shaft axis WA and to be more precise with entrainment of the circlip 19 (arrow B) by means of the bridge 23 engaging in the opening 22, so that the circlip 19 is ultimately demeshed from the wiper shaft 1 and the latter, together with the elements provided on the wiper shaft, is able to deflect by axial movement in the direction of the arrow A and indeed to such an extent that the wiper shaft 1 and the elements connected to the latter are at least moved back into the outline formed by the outside of the vehicle so that in the event of an accident involving a person, the risk of injury is considerably reduced by the deflection of the wiper shaft 1. Particularly by the shaping of the nose 17 and the angled surfaces 5.1.1 and 16 and 18, in addition to the design of the clip arms 19.1, the release force at which release of the axial securing for the wiper shaft 1 and deflection of this wiper shaft occur can be adjusted to the required value.

In the embodiment present, the notches 12 are provided respectively in the area of the lower edge of sections 11.1 and 11.2 of the circumferential wall 11 such that they safeguard the cover cap 9 against raising from the pivot component, but not however against displacement radially in relation to the wiper shaft axis WA and parallel to sections 11.1 and 11.2.

FIG. 4 shows an embodiment in which instead of the cover cap 9, a cover cap 9a is provided which among other aspects is supported by a nose 24 formed on the inside of section 11.3 of the circumferential wall 11 on the upper side of the pivot component 5 and by the wall section 10 on the raised section 5.1 of this pivot component. At the bottom edge of section 11.3, a bridge 23a corresponding to the bridge 23 is formed, which in turn engages from the side facing away from the vehicle bodywork 4 in the control opening 22 of the circlip 19. On the site facing away from the wiper shaft axis WA, the bridge 23a is provided with an angled surface 25, so that in case of an application of force F that exceeds the release force on the upper side of the cover cap 1, the cap fixing effected by the nose 24 is overcome and the cover cap 9a yields by pivoting around the support on section 5.1, as a result of which the circlip 19 is radially detached from the wiper shaft 1 (arrow B) by means of the angled surface 25 and consequently the wiper shaft is released for axial deflection in the direction of the arrow A.

As implied by the broken line 2.1 in FIG. 4, the external diameter of the wiper shaft bearing 2 can be increased, so that the outer surface of the wiper shaft bearing 2 serves to support the bridge 23a on releasing the circlip 19.

FIG. 5 shows a further embodiment with a cover cap 9b, which is designed interiorly with slightly malleable bridges 26, by which the cover cap 9b is supported on the upper side of the pivot component 5. In the pivot component 5, a tappet 27 is provided in an axis direction parallel to the wiper shaft axis WA and axially displaceable, which at its end projecting over the bottom side of the pivot component 5 reaches into the control opening 22 of the circlip 19 and forms in the area of this end on a side facing away from the wiper shaft axis WA a control and angled surface 28. With the upper end forming a rounded head 29 in the embodiment presented, the tappet is adjacent to the inside of the upper wall section 10 of the cover cap 9b. The bolt 27 is secured in its position represented in FIG. 4 by shearable projections or elevations 30 and 31. If an application of force F that exceeds the release force is exerted on the cover cap 9b, the cover cap 9b is moved with distortion of the bridge 26 in the direction of pivot component 5, as a result of which the tappet 27 is carried with it and moves in case of the representation selected for FIG. 4 axially downwards, i.e. in the direction of the vehicle bodywork 4 and release of the circlip 19 from the wiper shaft 1 (arrow B) subsequently occurs by means of the control surface 28, so that the wiper shaft 1, after elimination of the axial securing is able to deflect axially, i.e. in the direction of arrow A. The release force is essentially adjustable by corresponding dimensioning of the bridges 26, the upper projection 30 and the angled surface 28.

FIG. 6 shows in a representation like FIG. 1 a further embodiment with a cover cap 9c. This cover cap corresponds to cover cap 9b and is supported in turn by the bridges 26 on the upper side of the pivot component 5 facing away from the wiper shaft bearing 2. By means of the notches 12, the cover cap 9c is safeguarded against raising from the pivot component 5.

The pivot component 5 is provided in addition to the section 5.1 presenting the bearing opening 6 with a further section 5.2, which likewise projects over the side of the pivot component 5 facing away from the wiper shaft bearing 2 and to which a cranked lever 32 is hinged by a pivot bolt 33 around an axis vertical to the wiper shaft axis WA. The lever 32 forms two lever arms 32.1 and 32.2, which respectively extend away from the articulation formed by the axis 33. The arm 32.1 ends with a broadened head section 34 directly under the upper wall section 10 of the cover cap 9c. The end of the lever arm 32.2 engages in the control opening 2 of the circlip 19. In case of an application of force F exceeding a predetermined release force on the cover cap 9c, the latter is moved with yielding of the bridges 26 among other aspects in the direction of the pivot component 5, as a result of which the lever 32 is pivoted by means of the head section 34 in the representation selected for FIG. 6 clockwise around the articulation axis 33 and consequently by means of the lever arm 32.2 engaging in the control opening 22, the circlip 19 is displaced outwards by movement radially in relation to the wiper shaft axis WA and is demeshed from the wiper arm 1, so that the latter is in turn able to deflect axially according to the arrow A. By appropriate design of the bridges 26, the circlip 19 and the clip arms 19.1 in addition to appropriate choice of the lever ratio between the lever arms 32.1 and 32.2, the release force, the exceeding of which results in lifting of axial securing for the wiper shaft 1 can be set to the respective required value. In the embodiment represented, section 5.2 is arranged diametrically opposite section 5.1 with reference to the wiper shaft axis WA.

FIG. 7 shows an embodiment with a cover cap 9d, which is designed in this embodiment in such a way that the rearward section 11.3 of the circumferential wall 11 forms a lever, which is swivel-connected by means of an articulation point 35 to the upper wall section 10. as a deviation from the embodiments described above, the section 11.3 is not connected to the lateral sections 11.1 and 11.2 of the circumferential wall of the cover cap 9d and therefore the wall section 11.3 is able to pivot around the articulation 35 and around the axis of this articulation oriented vertically in relation to the wiper shaft axis WA, as implied by the arrow C. The articulation 35, in the embodiment presented, is formed in a similar manner to a film hinge from a section with reduced material thickness. The section 11.3 is angled in relation to the wiper shaft axis WA and to be more precise in such a way that this section forms with the plane E an angle γ smaller than 90° and in the embodiment presented an angle γ somewhat larger than 45°, which opens towards the wiper shaft axis WA. On the lower edge distant from the articulation 35, the section 11.3 is supported on a thrust bearing 36, which is provided on the end distant from the wiper shaft 1 of the section 19.2 of the axial securing element 19. The thrust bearing 36 consists in this case of plastic for example and is produced by injection on to the circlip 19, with the plastic material also filling in the control opening 22. It is fundamentally also possible to manufacture the circlip 19 from plastic in one piece with the thrust bearing 36. The cover cap 9d is supported by bridges not illustrated on the upper side of the pivot component 5.

In case of an application of force F exceeding the release force on the cover cap 9d, the latter is displaced in turn in the direction of pivot component 5, with as a result of the articulation 35 and the angling of the section 11.3, the latter pivoting radially outwards with its bottom edge distant from the articulation 35 in relation to the wiper shaft axis WA and to be more precise with entrainment of the circlip 19 (arrow B). The latter is consequently radially detached from the wiper shaft 1, so that the wiper shaft 1 is in turn released for axial deflection according to the arrow A.

The release force, the exceeding of which results in release of the wiper shaft 1 for axial deflection is determined in this embodiment among other aspects by the design of the circlip 19 and the clip arms 19.1 at this position in addition to the angle of the section 11.3 of the circumferential wall 11.

Common to all the examples of embodiment described above is that by means of a triggering or unlocking mechanism, the movement of the cover cap 9 and 9a-9d in the direction of the pivot component 5 in case of an external application of force F exceeding a release force is transformed into a movement that results in radial detachment of the securing element serving for axial securing of the wiper shaft, that is to say, in the embodiments presented, for radial detachment of the circlip 19 from the wiper shaft 1.

FIG. 8 shows a further embodiment which corresponds to the embodiment in FIG. 5, but without the cover cap 9b however and in which the triggering or unlocking mechanism that triggers the protection function does not include a cover cap and is also not actuated by means of a cover cap. The triggering or unlocking mechanism in this embodiment is essential formed by the tappet 27 not covered by a cap, i.e. arranged as exposed, which reaches into the control opening 22 of the circlip 19 with its angled or control surface 28. The tappet 27 is again arranged in a drilling in the pivot component 5 with its axis parallel to the wiper shaft axis WA and safeguarded against axial displacement by the projections or elevations 30 and 31 in the initial position represented. If an application of force F that exceeds the release force is exerted on the tappet 27 or its head, the tappet 27 in the representation selected for FIG. 8 is moved downwards, so that radial detachment of the circlip 19 from the wiper shaft 1 (arrow B) occurs by means of the control surface 28 and the wiper shaft 1, after this elimination of the axial securing, is able to deflect axially, i.e. in the direction of the arrow A. The release force with this embodiment is essentially adjustable by the dimensioning of the shearable projection 30 and by the selection of material for the tappet 27 and therefore also for the projection 30. The wiper shaft end 1.1 and the nut provided on this end are covered by an auxiliary cap 37, which is for example a plastic moulded component.

FIG. 9 shows an embodiment which corresponds to the embodiment in FIG. 6, but without the cover cap 9c however. The lever 32 hinged to the pivot component 5 and forming the triggering or unlocking mechanism in this embodiment has an exposed arrangement and interacts in turn with the free end of its lever arm 32.2 with the circlip 19 serving as an axial securing element, i.e. the free end of the lever arm 32.2 engages in the control opening 22. By non-illustrated catch or spring devices, the lever 32 is secured in its initial position represented in FIG. 9 in which the free end of the lever arm 32.1 and the head section 34 at this position are arranged in the axis direction of the wiper shaft 1 before the wiper shaft end 1.1 and before the nut 8 at this position and thus at least visual conceal the wiper shaft end 1.1 and the nut 8. In case of an application of force F exceeding a predetermined release force on the head section 34, the lever 32 in the representation selected for FIG. 9 is pivoted clockwise around the axis 32 and therefore the circlip 19 is radially detached from the wiper shaft 1 (arrow B) by means of the lever arm 32.2 engaging in the control opening 22 and therefore demeshed from this wiper shaft 1, so that the latter is able to deflect axially according to the arrow A. The release force, the exceeding of which results in lifting of axial securing for the wiper shaft 1 can be adjusted in this embodiment among other aspects by appropriate design of the circlip 19 and by the force required to detach the circlip 19 from the wiper shaft 1 and likewise by the design of the catch and/or spring elements securing the lever 32 in its initial position.

In the embodiments described above, the circlip 19 manufactured respectively from a flat material, for example spring steel, or from a suitable plastic, was used. FIG. 10 shows an embodiment in which a clip 38 manufactured from spring wire is used as an axial securing element. This forms two shanks 39 and a section 40 connecting these shanks. The clip 38 is shaped such that in its condition axially securing the wiper shaft 1, it overlaps the wiper shaft 1 in the area of the groove 21 and indeed in such a manner that the shanks 39 are respectively received with a pitch circle-shaped curved section 39.1 in the groove 21 and project with adjoining sections 39.2 and 39.3 from the groove 21. With the sections 39.2 and 39.3, the clip 38 for axial securing of the wiper shaft 1 by means of the flat washer and overrun washer 3.1. adjoins the wiper shaft bearing 2. The shanks 39 are again designed in such a way that their sections 39.1 encompass the wiper shaft 1 in the area of the groove 21 respectively over an angle range markedly greater than 90°. The two sections 39.3 form together with the section 40 a control opening which corresponds in terms of its function to the control opening 22 and in which the respective control or actuating element of the triggering or unlocking mechanism engages, as described above for the control opening 22 of the circlip 19. For elimination of the axial securing of the wiper shaft 1, the clip 38 is detached from the wiper shaft 1 with elastic deflection of the shanks 39.

FIG. 11 shows as a further embodiment an axial securing element in the form of a clip 38a manufactured from spring wire, which only essentially differs from the clip 38 in that the free ends of the shank sections 39.2 are connected to one another by means of a further eyelet-shaped section 39.4. The eyelet-shaped section 39.4 is designed in such a way in this case that its eyelet opening is larger than the diameter of the wiper shaft 1.

Elimination of the axial securing is again performed in this embodiment by radial detachment of the clip 38a from the wiper shaft 1, with after elimination of the axial securing, the clip 38a with the eyelet-shaped section 39.4 continuing to be held loosely on the wiper shaft 1, thereby avoiding being lost.

FIG. 12 shows as a further embodiment an axial securing element in the form of a splint 42 manufactured from metal or plastic. The wiper shaft 1 presents in this embodiment a radial drilling 43, through which the splint 42 reaches, which projects with both ends from the drilling 43 and with these ends respectively adjoins the wiper shaft bearing 2 for axial securing of the wiper shaft 1 by means of the overrun washer 3.1. One end of the splint 42 forms an eyelet-shaped opening 44, which in terms of function corresponds to the control openings 22 and 41.

It is however understood that many modifications and variations are possible without as a result departing from the concept on which the invention is based. It is therefore also possible for example to design securing elements serving for axial securing of the wiper shaft 1 in normal operation differently from that which is described above, for example in the form of a pin engaging in a circumferential groove or radial drilling of the wiper shaft, etc.

In order during normal wiping operation to relieve the release or unlocking mechanism between the respective cover cap 9, 9a-9d from any moments exerted by the circlip 19 and resulting from friction between this clip and the wiper shaft bearing 2, it is also possible to design the connection between the wiper shaft and the axial securing element in such a way that although the latter is provided to be detachable on the wiper shaft, it is however held in a torque proof manner on the wiper shaft 1 during normal operation, for example by design of the wiper shaft 1 in the area of the groove 21 with a cross-section other than circular by designing the axial securing element as a pin etc.

As additional accident protection, the groove 21 may also be rounded or angled on its side facing the pivot component 5, so that in case of malfunction of the triggering or unlocking mechanism, i.e. in an extreme case axial deflection of the wiper shaft 1 and of the functional elements connected to the latter by is possible by over-depressing the circlip 19.

The clip 38a is therefore designed in the form of a wire strap in the same manner as clip 38.

### LIST OF REFERENCES

1 Wiper shaft
1.1 Wiper shaft end
2 Wiper shaft bearing
2.1 Enlarged diameter of the wiper shaft bearing
3 Bearing bush
3.1 Overrun washer
4 Vehicle bodywork
5 Pivot component
5.1, 5.2 Section of the pivot component
5.1.1 Angled surface on section 5.1
6 Bearing opening
7 Opening in the pivot component for wiper shaft
end 1.1
8 Nut
9, 9a-9d Cover cap
10 Upper wall section
11 Circumferential wall
11.1-11.3 Section of circumferential wall 11
12 Notches
13 Bridge
14 Space inside the cover cap
15 Bridge
16 Angled surface
17 Nose
18 Angled surface
19 Circlip
19.1 Clip arm
19.2 Clip section
21 Groove in the wiper shaft 1 for circlip
21.1 Axial supporting surface on the wiper shaft side
22 Control opening
23, 23a Bridge
24 Nose
25 Angled surface
26 Bridge
27 Tappet
28 Angled surface or control surface on the tappet 27
29 Head
30, 31 Projection
32 Lever
32.1, 32.2 Lever arm
33 Pivoting axis
34 Head section
35 Articulation
36 Thrust bearing
37 Auxiliary cap
38, 38a Clip
39 Shank
39.1, 39.2, 39.3, 39.4 Shank section
40 Yoke section
41 Control opening
42 Splint
43 Drilling
44 Control opening
A axial deflection of the wiper shaft 1
B detachment movement of the circlip

1. A wiper module for vehicle front windscreens, comprising:
at least one wiper shaft mounted in a wiper shaft bearing and driven by a wiper gear;
a wiper arm end fixed at one wiper shaft end; an axial securing element for securing the at least one wiper shaft against axial displacement,
wherein the axial securing element, in case of an external application of force exceeding a release force on the at least one wiper shaft and the wiper arm end, releases the wiper shaft for an axial deflection movement,
wherein a release or unlocking mechanism is provided in addition to the at least one wiper shaft which, in case of the application of force exceeding the release force, renders the axial securing element out of action for a subsequently released axial deflection movement of the at least one wiper shaft.

2. The wiper module according to claim 1, wherein the release or unlocking mechanism, during the application of force exceeding the release force, results in removal of the axial securing element from the at least one wiper shaft and demeshing of the axial securing element from the at least one wiper shaft for release of the axial deflection movement in relation to the wiper shaft bearing.

3. The wiper module according to claim 1, wherein a pivot component of the wiper arm end fixed to the wiper shaft end is provided with a cover cap which, during the application of force exceeding the release force, is moved in relation to the pivot component and which, by means of the release or unlocking mechanism, results in removal of the axial securing element from the at least one wiper shaft for release of the axial deflection movement.

4. The wiper module according to claim 3, wherein the cover cap is part of the release or unlocking mechanism.

5. The wiper module according to claim 1, wherein the axial securing element, for release of the at least one wiper shaft, is movable radially in relation to the at least one wiper shaft.

6. The wiper module according to claim 1, wherein the axial securing element, in the securing state, engages behind an axial support surface formed on the at least one wiper shaft and on the wiper shaft side.

7. The wiper module according to claim 6, wherein the axial support surface on the wiper shaft side is formed by a recess in the at least one wiper shaft by a drilling or a groove in the at least one wiper shaft.

8. The wiper module according to claim 1, wherein the axial securing element, in the securing state, is axially supported on the wiper shaft bearing and on an axial support surface formed or existing on the wiper shaft bearing.

9. The wiper module according to claim 1, wherein the axial securing element, in securing the at least one wiper shaft, is designed for turning with and pivoting with the at least one wiper shaft during wiping operation of the wiper module.

10. The wiper module according to claim 1, wherein the axial securing element is manufactured from one of metal and plastic.

11. The wiper module according to claim 1, wherein the axial securing element is designed in the manner of one of a pin and a splint in at least a subarea.

12. The wiper module according to claim 1, wherein the axial securing element is an element overlapping the at least one wiper shaft in the manner of a fork in the area of the axial support surface on the wiper shaft side, wherein the axial securing element is one selected from a group consisting of a clip and a circlip.

13. The wiper module according to claim 12, wherein the circlip is designed flat with at least two clip arms overlapping the at least one wiper shaft in the area of the axial support surface on the wiper shaft side.

14. The wiper module according to claim 12, wherein the clip is designed in the manner of a wire strap.

15. The wiper module according to claim 3, wherein the release or unlocking mechanism is designed such that a movement of the cover cap caused by an application of force exceeding the release force or a component of this movement in the direction of the wiper shaft axis causes radial detachment of the axial securing element from the at least one wiper shaft.

16. The wiper module according to claim 15, wherein a section of the cover cap is related in terms of action with the axial securing element.

17. The wiper module according to claim 16, wherein the cover cap meshes with a bridge in a control or entrainer opening of the axial securing element.

18. The wiper module according to claim 16, wherein the cover cap with the section adjoins a thrust bearing on the axial securing element.

19. The wiper module according to claim 15, wherein the at least one angled surface is provided on the cover cap and interacts with a counter-surface with an angled surface on the pivot component.

20. The wiper module according to claim 1, wherein the release or unlocking mechanism presents at least one control surface in the form of an angled surface, particularly for transformation of a movement in the direction of the wiper shaft axis into a movement radially in relation to the wiper shaft axis.

21. The wiper module according to claim 15, wherein the at least one angled surface is formed on the pivot component and the cover cap is supported on this angled surface.

22. The wiper module according claim 15, wherein the at least one angled surface is provided on the section or bridge of the cover cap meshing in a control or entrainment opening.

23. The wiper module according to claim 19, wherein the section at an end distant from the axial securing element interacting with the axial securing element is pivot-connected to the cover cap by means of an articulation and forms an angle of less than 90° and preferably an angle of more than 45° with a plane oriented vertically to the wiper shaft axis.

24. The wiper module according to claim 23, wherein the section is part of the wall of the cover cap.

25. The wiper module according to claim 3, wherein a control element provided on the pivot component is at least a part of the release or unlocking mechanism and which, in case of an application of force exceeding the release force, by movement in relation to the pivot component, causes release of the at least one wiper shaft for the axial deflection movement.

26. The wiper module according to claim 25, wherein the control element is provided as displaceable on the pivot component.

27. The wiper module according to claim 25, wherein the control element is an axially displaceable pin in the pivot component which, with a control or angled surface, interacts with an entrainment surface of the axial securing element formed by the control opening.

28. The wiper module according to claim 25, wherein the control element is a lever swivel-mounted on the pivot component which is arranged with one end of a first lever arm under the cover cap and interacts with the end of a second lever arm with an entrainment surface formed by a control opening of the axial securing element.

29. The wiper module according to claim 3, wherein the cover cap is supported on the pivot component by means of malleable noses and malleable bridges.
